(19) United States
(12) Patent Application Publication
(10) Pub. No.: US 2011/0315542 A1
(43) Pub. Date: Dec. 29, 2011

(54) SYSTEM FOR PROCESSING ORGANIC MATERIAL USING SOLAR ENERGY

(75) Inventors: MAZEN ABDULLAH BA-ABBAD, Riyadh (SA); ALI ABDULLAH A. ALJALOUD, Riyadh (SA); AHMED MOHAMMED ALABDULKADER, Riyadh (SA)

(73) Assignee: KING ABDUL AZIZ CITY FOR SCIENCE AND TECHNOLOGY, RIYADH (SA)

(21) Appl. No.: 12/825,743

(22) Filed: Jun. 29, 2010

(51) Int. Cl. C07B 63/00; B01J 19/08

(52) U.S. Cl. 204/157.6; 204/158.21; 422/186

(57) ABSTRACT

The invention provides a system for processing organic material using solar energy. The system includes a flat mirror reflecting unit configured to rotate around a dual axis of the flat mirror reflecting unit in order to receive sunlight from the sun. The flat mirror reflecting unit reflects the sunlight in response to receiving the sunlight. The system further includes a fixed concentrating Fresnel mirror unit for receiving the sunlight reflected by the flat mirror reflecting unit. The system also includes a sliding tray unit which receives organic material. The sliding tray unit is positioned such as to receive the sunlight reflected by the fixed concentrating Fresnel mirror unit. The sliding tray unit receives the sunlight concentrating on a focal region of the sliding tray unit. Upon receiving the sunlight on the sliding tray unit, the organic material in the sliding tray unit is subjected to thermal processing using solar energy of the sunlight.

### FIELD OF THE INVENTION

The present invention generally relates to processing of organic material, and more specifically, to a system for thermal processing of the organic material using solar energy.

### BACKGROUND OF THE INVENTION

Nowadays method of decomposing organic material such as plastic refuse, food remains manure, slaughter remains, and decomposed plants is a matter of concern. Usually, the organic material is dumped in dumpsters and left unattended. Such handling of the organic material results in decaying of the organic material and producing various harmful gases such as methane, and ammonia along with foul smell. In addition, the decaying organic material attracts harmful insects and rats. Further, organic material such as a plastic waste takes long time to decompose and poses a threat to environment.

Several methods are known for processing these organic materials. However, such methods are not appropriate to handle both bio-waste and plastic waste. Further, there are methods for decomposing the organic material which utilizes bioreactors. Such methods for decomposition of the organic material are used in order to produce methane gas for industrial purpose. In order to produce methane gas from the decomposition of the organic material, setup of large power plants is required. Moreover, in order to produce methane gas, the organic material is subject to decay for years. In addition, there are methods for decomposition of the organic material which involves openly burning of the organic material in presence of air. However, burning of the organic material results in highly alkaline char resulting into contamination of environment. Alternatively, the organic material may be decomposed in the presence of micro-organisms. However, the decomposition of the organic materials in the presence of micro-organisms is a time consuming method. Further, the micro-organisms are unable to decompose organic material such as plastic-waste.

Additionally, there are methods for decomposition of organic material by using solar energy. Such methods include a complex set up of huge parabolic dish mirrors for collecting sunlight in order to heat the organic material. These methods may also require large storage containers for storing the organic material. In order to set up a system for carrying out such methods, large area is required. Therefore, cost of setting up such a system would go high. However, the set up of such a system may not be feasible in a city, or a metropolitan.

Therefore, there is a need for a system for efficiently and economically processing organic material while reducing harmful effects caused due to inappropriate handling of the organic material.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the invention.

FIG. 1 illustrates a system for processing organic material in accordance with various embodiment of the invention.

FIG. 2 illustrates an exemplary system for processing organic material in accordance with an embodiment of the invention.

FIG. 3 illustrates a gas extracting unit for extracting one or more gases in accordance with various embodiment of the invention.

FIG. 4 illustrates a flow diagram of a method for processing organic material in accordance with various embodiment of the invention.

FIG. 5 illustrates a flow diagram of a method for thermal processing of organic material in accordance with various embodiment of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the invention.

### DETAILED DESCRIPTION OF THE INVENTION

Before describing in detail embodiments that are in accordance with the invention, it should be observed that the embodiments reside primarily in combinations of method steps and apparatus components related to method and system for processing organic material using solar energy. Accordingly, the apparatus components and method steps have been represented where appropriate by conventional symbols in the drawings, showing only those specific details that are pertinent to understanding the embodiments of the invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

Various embodiments of the invention provide a system for processing organic material using solar energy. The system includes a flat mirror reflecting unit configured to rotate around a dual axis of the flat mirror reflecting unit in order to receive sunlight from the sun. The flat mirror reflecting unit reflects the sunlight in response to the sunlight received. The system further includes a fixed concentrating Fresnel mirror unit for receiving the sunlight reflected by the flat mirror reflecting unit. The system also includes a sliding tray unit which receives organic material. The sliding tray unit is positioned such as to receive the sunlight reflected by the fixed concentrating Fresnel mirror unit. The sliding tray unit receives the sunlight concentrating on a focal region of the sliding tray unit. Upon receiving the sunlight on the sliding tray unit, the organic material in the sliding tray unit is subjected to thermal processing using solar energy of the sunlight.

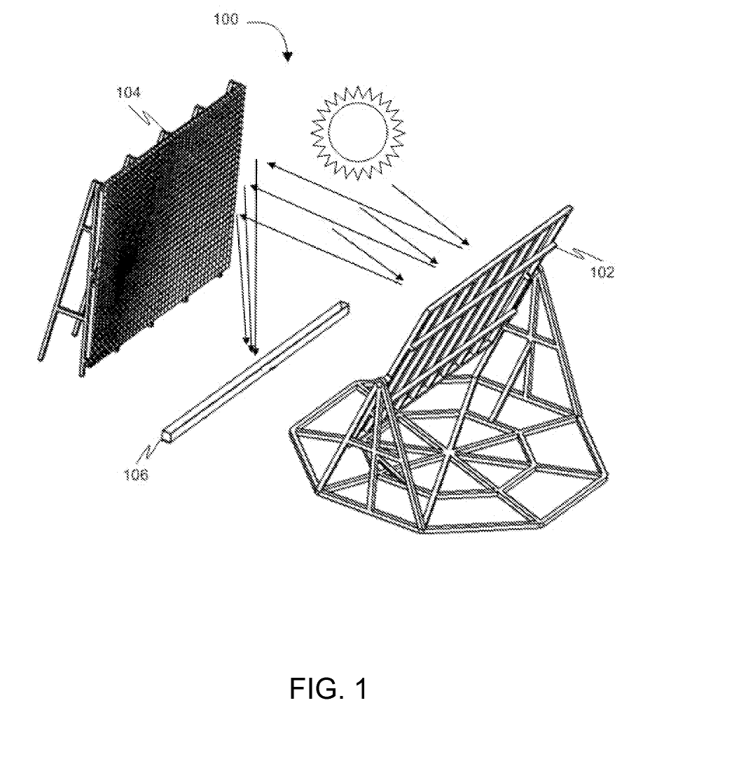

FIG. 1 illustrates a system 100 for processing organic material. As shown in FIG. 1, system 100 includes a flat mirror reflecting unit 102. Flat mirror reflecting unit 102 is configured to rotate around a dual axis of flat mirror reflecting unit 102 in order to receive sunlight from the sun. The dual axis of flat mirror reflecting unit 102 is used to track azimuth and elevation of the sun. In response to receiving the sunlight from the sun, flat mirror reflecting unit 102 reflects the sunlight. System 100 further includes a fixed concentrating Fresnel mirror unit 104 that receives the sunlight reflected by flat mirror reflecting unit 102. Thereafter, fixed concentrating Fresnel mirror unit 104 reflects the sunlight on a sliding tray unit 108. Sliding tray unit 108 is configured to receive organic material. The organic material may include, but is not limited to, plastic waste, food remains, slaughter remains, and decomposed plants. Sliding tray unit 108 is positioned in a manner to receive the sunlight concentrating on a focal region of sliding tray unit 108. Upon receiving the sunlight reflected by fixed concentrating Fresnel mirror unit 104, the organic material residing in sliding tray unit 108 is subjected to thermal processing by using solar energy of the sunlight.

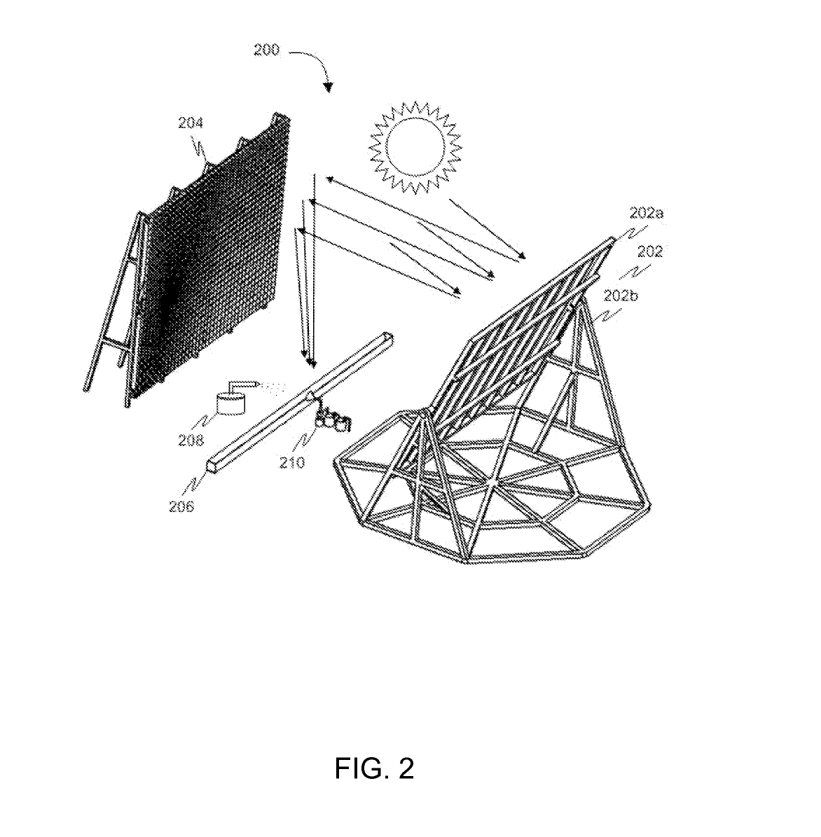

FIG. 2 illustrates an exemplary system 200 for processing organic material in accordance with an embodiment of the invention. As shown in FIG. 2, system 200 includes a flat mirror reflecting unit 202. Flat mirror reflecting unit 202 further includes a flat mirror 202a, and a tracking unit 202b. Flat mirror 202a is configured to rotate around a dual axis of flat mirror reflecting unit 202 in order to receive sunlight from the sun. Further, tracking unit 202b is configured to track azimuth and elevation of the sun. In response to receiving the sunlight from the sun, flat mirror reflecting unit 202 reflects the sunlight. System 200 further includes a fixed concentrating Fresnel mirror unit 204 that receives the sunlight reflected by flat mirror reflecting unit 202.

Thereafter, fixed concentrating Fresnel mirror unit 204 reflects the sunlight on a sliding tray unit 206. Sliding tray unit 206 is configured to receive organic material. The organic material may include, but is not limited to, plastic waste, food remains, slaughter remains, and decomposed plants. Sliding tray unit 206 is further configured to enable movement of the organic material inside sliding tray unit 206. As a result, sliding tray unit 206 provides an efficient loading and unloading of the organic material. In addition to receiving the organic material, sliding tray unit 206 may further include receiving, but are not limited to, lime, limestone, sand, and refractory material. Sliding tray unit 206 is positioned in a manner to receive the sunlight concentrating on a focal region of sliding tray unit 206. Upon receiving the sunlight reflected by fixed concentrating Fresnel mirror unit 204, the organic material residing in sliding tray unit 206 is subjected to thermal processing by using solar energy of the sunlight.

The thermal processing of the organic material involves treating the organic material with one or more of, but not limited to, lime, limestone, sand, and refractory material. As a result of treating the organic material, one or more of one or more gases and one or more byproducts are obtained. The one or more gases may include, but is not limited to, hydrogen, carbon monoxide, and acetylene. Further, the one or more byproducts may include, but is not limited to, carbon char, calcium oxide, and calcium carbide. For example, an organic material is thermally processed by treating the organic material with lime stone (Calcium Carbonate) in order to obtain lime (Calcium Oxide) and carbon dioxide. The chemical reaction that occurs during the thermal processing of the organic material is represented as:

Organic Material+CaCO₃→CaO+CO₂

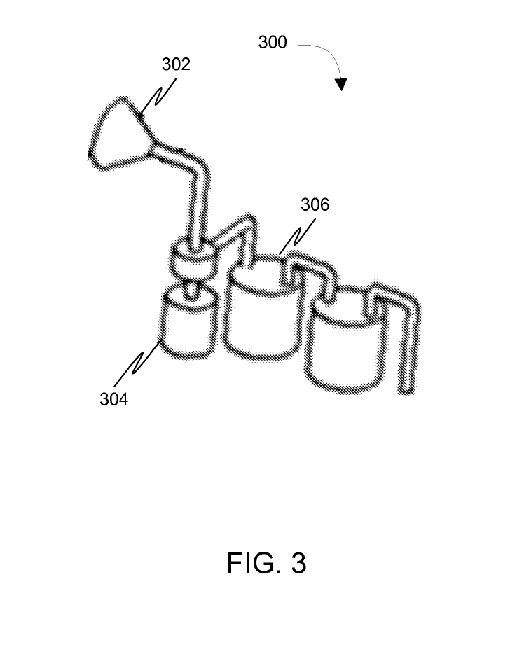

The carbon dioxide obtained as a result of thermal processing of the organic material with lime is collected using a system explained in detail in conjunction with FIG. 3.

Further, the organic material is heated on a high temperature in order to obtain carbon char. Subsequently, carbon char is thermally processed by treating carbon char with lime in order to obtain calcium carbide and carbon monoxide. The chemical reaction that occurs during the thermal processing of carbon char with the lime is represented as:

CaO+3C→CaC₂+CO

Alternatively, carbon char may be collected from sliding tray unit 206 and used for industrial purpose. Upon obtaining carbon monoxide as result of treating carbon char with lime, carbon monoxide is collected using a system explained in detail in conjunction with FIG. 3.

Thereafter, calcium carbide is thermally processed by treating calcium carbide with water in order to obtain acetylene and calcium hydroxide. In an embodiment, system 200 includes a water container which is not shown in FIG. 2. The water container is configured to store and supply water to sliding tray unit 206. The chemical reaction that occurs during the thermal processing of calcium carbide with water is represented as:

CaC₂+H₂O→C₂H₂+Ca(OH)₂

Acetylene obtained as a result of thermal processing of calcium carbide with water is collected using a system explained in detail in conjunction with FIG. 3. Further, acetylene may be processed to obtain ethylene. Ethylene obtained from acetylene may be further processed to manufacture polyethylene. Alternatively, ethylene may be processed by hydrating ethylene to obtain ethanol. In addition, calcium hydroxide may be recycled to produce lime.

In an embodiment, the thermal processing of the organic material may include burning the organic material in a partially opened sliding tray unit 206. Therefore, the burning of the organic material takes place in presence of ambient air.

In addition, system 200 includes a spraying unit 208 for spraying one or more gases on sliding tray unit 206. The one or more gases may include, but are not limited to, steam, and carbon dioxide. Spraying unit 208 is removably connected to sliding tray unit 206 for spraying the one or more gases in order to thermally process the organic material.

In an exemplary embodiment, the organic material is plastic waste; the plastic waste is thermally processed in order to obtain one or more gases. The one or more gases may include, but is not limited to, hydrogen, and carbon monoxide. The one or more gases are further processed in order to obtain one or more hydrocarbon fuels. For example, hydrogen and carbon monoxide are further processed using Fischer-Tropsch process in order to obtain one or more hydrocarbon fuels. The chemical reaction that occurs during the Fischer-Tropsch process is represented as:

(2n+1)H₂+nCO→CₙH₍₂ₙ₊₂₎+nH₂O

In another exemplary embodiment, the organic material is bio-waste; the bio-waste is thermally processed in order to obtain one or more solid byproduct. A solid byproduct may include but is not limited to bio-char. The bio-char includes water soluble nitrates, phosphates, and potassium. In addition, the bio-char may further include, but is not limited to, micro-nutrients such as iron, copper, and magnesium. The bio-char obtained from the thermal processing of the bio-waste may be used as fertilizers.

Upon obtaining the one or more gases in response to treating the organic material, the one or more gases are extracted from sliding tray unit 206. The one or more gases are extracted by a gas extracting unit 210. In order to extract the one or more gases, gas extracting unit 210 is removably connected to a hole of sliding tray unit 206. In addition to obtaining the one or more gases, the one or more byproducts are extracted from sliding tray unit 206. In an embodiment, sliding tray unit 206 is replaced with another sliding tray unit in order to extract the one or more byproducts.

FIG. 3 illustrates a gas extracting unit 300 for extracting one or more gases. Gas extracting unit 300 includes a funnel unit 302, a gas pump unit 304, and a gas cleaning unit 306.

As shown in FIG. 3, funnel unit 302 is configured for extracting one or more gases from sliding tray unit 212. The one or more gases are obtained in response to thermal processing of organic material in sliding tray unit 212 as explained in detail in conjunction with FIG. 2. In order to extract the one or more gases, funnel unit 302 is removably connected to a hole of sliding tray unit 212. Further, gas pump unit 304 is also removably connected to funnel unit 302 for sucking the one or more gases from sliding tray unit 212. Upon sucking the one or more gases, gas cleaning unit 306 receives the one or more gases from gas pump unit 304 which is removably connected to gas cleaning unit 306. The one or more gases are purified by gas cleaning unit 306 using one or more of water bath, an alkaline bath, and an acid bath. Further, the one or more gases are purified by bubbling the one or more gases through the baths.

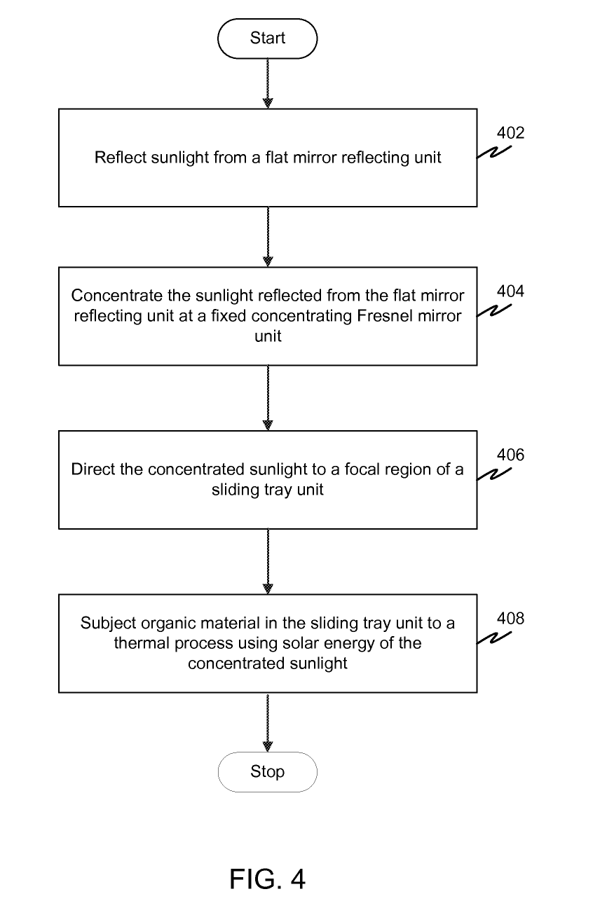

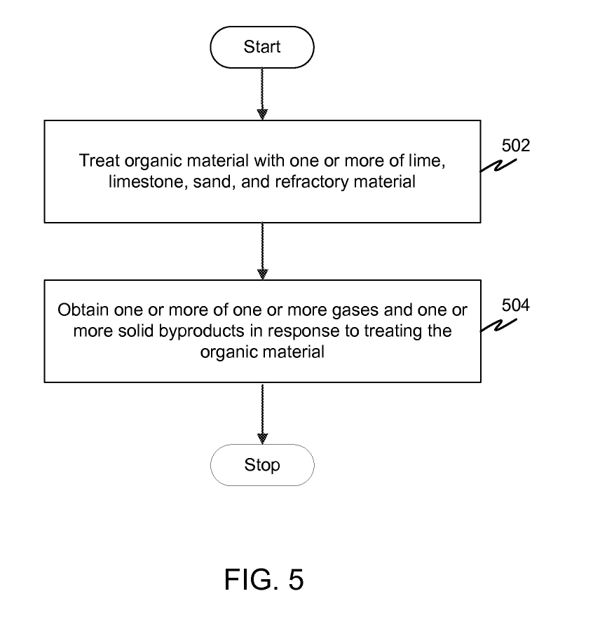

FIG. 4 illustrates a flow diagram of a method for processing organic material. As shown in FIG. 4, sunlight is reflected from a flat mirror reflecting unit at step 402. The flat mirror reflecting unit is configured to rotate around a dual axis of the flat mirror reflecting unit in order to receive the sunlight from the sun. Further, the sunlight reflected from the flat mirror reflecting unit is concentrated at a fixed concentrating Fresnel mirror unit at step 404. Upon receiving the concentrated sunlight, at step 406, the concentrated sunlight is directed to a focal region of a sliding tray unit. Thereafter, at step 408, organic material residing in the sliding tray unit is subjected to a thermal process by using solar energy of the concentrated sunlight at the focal region of the sliding tray unit as explained in conjunction with FIG. 5.

FIG. 5 illustrates a flow diagram of a method for thermal processing of organic material. As shown in FIG. 5, the organic material is treated with one or more of, but not limited to, lime, limestone, sand, and refractory material at step 502. As a result of treating the organic material, one or more of one or more gases and one or more byproducts are obtained at step 504. The one or more gases may include, but is not limited to, hydrogen, carbon monoxide, and acetylene. Further, the one or more byproducts may include, but is not limited to, carbon char, calcium oxide, and calcium carbide.

In an embodiment, when the organic material is plastic, the one or more gases are subjected to a first predefined process to obtain at least one hydrocarbon fuel. In another embodiment, wherein when the organic material is bio-waste, the one or more solid byproducts are subjected to a second predefined process to obtain fertilizers.

Various embodiments of the invention provide system for processing organic material using solar energy. The system utilizes solar energy of sunlight present in abundance for thermal processing of the organic material. In order to perform thermal processing of the organic material, the system utilizes a flat mirror reflecting unit and a fixed concentrating Fresnel mirror unit which are easy to install and economic. Further, the system includes processing of both bio-waste and plastic waste. In addition, the thermal processing of the organic material results in useful materials such as fuels, and fertilizers.

Those skilled in the art will realize that the above recognized advantages and other advantages described herein are merely exemplary and are not meant to be a complete rendering of all of the advantages of the various embodiments of the present invention.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of the present invention. The benefits, advantages, solutions to problems, and any element(s) that may cause any benefit, advantage, or solution to occur or become more pronounced are not to be construed as a critical, required, or essential features or elements of any or all the claims. The present invention is defined solely by the appended claims including any amendments made during the pendency of this application and all equivalents of those claims as issued.

What is claimed is:

1. A system for processing organic material, the system comprising:
a flat mirror reflecting unit, the flat mirror reflecting unit being configured to rotate around a dual axis of the flat mirror reflecting unit for receiving sunlight, wherein the flat mirror reflecting unit reflects the sunlight in response to receiving the sunlight;
a fixed concentrating Fresnel mirror unit, wherein the fixed concentrating Fresnel mirror unit receives the sunlight reflected by the flat mirror reflecting unit; and
a sliding tray unit, the sliding tray unit receiving the organic material therewithin, the sliding tray unit being positioned to receive the sunlight reflected by the fixed concentrating Fresnel mirror unit on a focal region of the sliding tray unit, wherein the organic material in the sliding tray unit is subject to a thermal processing using solar energy of the sunlight received by the sliding tray unit.

2. The system of claim of 1, wherein the thermal processing comprises:
treating the organic material with at least one of lime, limestone, sand and refractory material; and
obtaining at least one gas and at least one solid byproduct in response to treating the organic material.

3. The system of claim 2, wherein a gas of the at least one gas comprises one of hydrogen, carbon monoxide, and acetylene.

4. The system of claim 2, wherein the at least one solid byproduct comprises at least one of carbon char, calcium oxide, and calcium carbide.

5. The system of claim 2 further comprising a gas extracting unit, wherein the gas extracting unit is adaptively coupled to the sliding tray unit to extract the at least one gas from the sliding tray unit.

6. The system of claim 5, wherein the gas extracting unit comprises:
a funnel unit, the funnel unit being adaptively coupled to the sliding tray unit;
a gas pump unit, the gas pump unit being adaptively coupled to the funnel unit, wherein the gas pump unit sucks the at least one gas from the sliding tray unit; and
a gas cleaning unit, the gas cleaning unit adaptively coupled to the gas pump unit to receive the at least one gas from the sliding tray unit.

7. The system of claim 6, wherein the funnel unit is adaptively coupled to a hole of the sliding tray unit for extracting the at least one gas from the sliding tray unit.

8. The system of claim 6, wherein the gas cleaning unit comprises at least one of a water bath, an alkaline bath and an acid bath for purifying the at least one gas received from the sliding tray unit.

9. The system of claim 8, wherein when the organic material is plastic, the at least one gas is subject to at least one first predefined process to obtain at least one hydrocarbon fuel.

10. The system of claim 8, wherein when the organic material is bio-waste, the at least one solid byproduct is subject to at least one second predefined process to obtain fertilizers.

11. The system of claim 1, wherein the thermal processing of the organic material is performed in presence of ambient air in the sliding tray unit.

12. The system of claim 1, wherein the flat mirror reflecting unit comprises:
a tracking unit, wherein the tracking unit is configured to rotate the flat mirror around the dual axis of the flat mirror reflecting unit for tracking azimuth and elevation of the sun.

13. The system of claim 1 further comprising a spraying unit, wherein the spraying unit is configured to spray at least one of steam, and carbon dioxide on the sliding tray unit for performing the thermal processing of the organic material.

14. The system of claim 1, wherein the organic material comprises at least one of plastic waste, food remains, slaughter remains, and decomposed plants.

15. The system of claim 14, wherein the plastic waste is subject to the thermal processing to obtain polyethylene.

16. A method for processing organic material, the method comprising:
reflecting sunlight from a flat mirror reflecting unit, the flat mirror reflecting unit rotatable around a dual axis;
concentrating the sunlight reflected from the flat mirror reflecting unit at a fixed concentrating Fresnel mirror unit;
directing the concentrated sunlight to a focal region of a sliding tray unit; and
subjecting organic material residing in the sliding tray unit to a thermal process using solar energy of the concentrated sunlight at the focal region.

17. The method of claim 16, further comprising:
treating the organic material with at least one of lime, limestone, sand, and refractory material; and
obtaining at least one gas and at least one solid byproduct in response to treating the organic material.

18. The method of claim 17, wherein a gas of the at least one gas comprises one of hydrogen, carbon monoxide, and acetylene.

19. The method of claim 17, wherein the solid byproduct comprises one of carbon char, calcium oxide, and calcium carbide.

20. The method of claim 17, wherein the organic material is plastic, and further comprising subjecting the gas to a process for obtaining a hydrocarbon fuel.
